(19) United States
(12) Patent Application Publication
(10) Pub. No.: US 2005/0289517 A1
(43) Pub. Date: Dec. 29, 2005

(54) System and methods for client and template validation

(75) Inventors: Robert A. Balfe, Tewksbury, MA (US); Charles P. Imperato, Somerville, MA (US)

Correspondence Address: JAMES K. WEIXEL, ESQ.;BOWDITCH & DEWEY, LLP, 161 Worcester Road, P.O. Box 9320, Framingham, MA, 01701-9320, US

(73) Assignee: International Business Machines Corporation

(21) Appl. No.: 10/876,270

(22) Filed: Jun. 24, 2004

(51) Int. Cl. G06F 9/44

(52) U.S. Cl. 717/126

(57) ABSTRACT

A system and method for validating user developed applications operating in conjunction with distributed workforce collaboration systems is provided. The invention allows a user, such as a quality control engineer, to validate front and back end data as well as an application under test without requiring that the user be adept at computer programming. The validation tool runs in memory used by the application under test as a dynamic link library (DLL). As a result, the validator can monitor all actions of the application under test without adversely impacting normal operation of the application under test.

### BACKGROUND OF THE INVENTION

Management and workflow collaboration software systems are used by organizations to maintain the efficiency of workforces. Among other things, these systems, herein referred to as management systems, allow employees to communicate, obtain information, requisition products and services, generate documents, and perform online training. Management systems may also connect portions of an organization that are separated geographically. As a result, management systems are often spread across multiple servers coupled to the network. The distributed nature of management systems along with the requirement that they perform numerous operations simultaneously makes them very large and complex.

Adding to the complexity of management systems is the fact that many of these systems have evolved over time. This evolution has largely been driven by customer needs and has resulted in rather basic management systems evolving into the large, complex ones predominant today. In addition, users must be able to write their own software applications to extract maximum utility from management systems. The combination of old/new software executable instructions and customer developed software instructions may produce software environments that are difficult to troubleshoot. For example, an enterprise, or management system may be executing hundreds or thousands of software agents and instructions as a matter of normal operation. A software agent as used herein refers to any self-contained potentially adaptive software application or an executable sequence of instructions, typically written by an end user. These software agents can be short lived, i.e. having lifetimes of less than a second, or can be long-lived having lifetimes measured in hours or days. Some software agents may need to operate according to a schedule, while others are event driven. If software agents are not properly written, they may fail to operate at scheduled times, may fail to start when a triggering event occurs, may operate in infinite loops, run too long, or consume too many system resources such as memory.

Users may also write software instructions for performing input/output interactions with the management system. And, in addition, users may write applications making use of templates for facilitating usage of forms and data entry associated with the management system. Template-driven applications refer to software enabled applications which are primarily document based when they are accessed, edited or created. Examples of template-driven applications are, but are not limited to, spread sheets, database user interfaces, on-line requisition forms, personnel data input screens, and the like.

In many situations, user developed software must be tested for suitability in addressing its intended purpose and for troubleshooting applications that are not operating properly. In some environments, individuals performing software testing are not experienced software developers; and therefore, they may not be capable of operating sophisticated software debugging tools such as those used by programmers.

What is needed is a tool that allows non-programmers to create test logic and perform testing of complex software applications. In addition, such a tool should not adversely impair or impact the software applications under test.

### SUMMARY OF THE INVENTION

A preferred embodiment of the present invention includes a method for validating a software application comprised of machine-readable instructions operating on a computer. The method includes the steps of making an in process memory available, having at least a first portion and a second portion, making a processor available for executing the machine-readable instructions, loading the machine-readable instructions into the memory to cause the instructions to occupy the first portion and receiving a validator having function-executable instructions, wherein the validator is used for verifying the operation of the software application.

In accordance with another aspect of the present invention, an apparatus for validating the operation of a software application includes machine-readable instructions. The apparatus has a memory having a first portion and a second portion. The first portion of the memory stores a first set of instructions associated with the software application and the second portion stores a second set of instructions associated with a validator that validates the software while operating. The memory is further capable of letting the validator monitor the first portion of memory while the software application is operating. A processor is communicatively associated with the memory and responsible for executing the first and second sets of instructions thereby facilitating validation of the software application by the validator. A user interface is also communicatively associated with the processor and is used for displaying a validation result to a user in human-readable form. An output interface is provided and communicatively associated with the processor and used for providing a validation result to an external application.

A preferred embodiment of the present invention includes a method operating on a Notes client for validating the operation of a software application communicatively associated with a server coupled to a network and includes the steps of making an in process memory available. This memory is capable of holding a first set of machine-readable instructions in a first portion of the memory and a second set of machine-readable instructions in a second portion of the memory. The memory is further communicatively associated with a processor. The method includes loading a first set of instructions associated with the software application into the first portion of memory. And, further includes loading a second set of instructions associated with a validator into a second portion of memory. The second set of instructions is further capable of monitoring the first set of instructions to produce a validation result. The validation result being associated with the operation of the software. The method then makes the validation result available to a user interface.

In accordance with another aspect of the present invention, a computer program product having machine-readable instructions for causing a processor to perform a method for validating the operation of a software application operating on a computer. The method includes the steps of making a memory available, the memory having at least a first portion and a second portion loading a validator for use in validating operation of the software application, making the processor available for executing the machine-readable instructions, the machine-readable instructions including a first set associated with the software application and a second set associated with the validator, loading the first set of instructions into the first portion of memory, loading the second set of instructions into the second portion of memory, making the second portion available to the first portion, determining a validation result using the first set and the second set of instructions; and making the validation result available to a user interface.

The foregoing and other features and advantages of the system and method for client and template validation will be apparent from the following more particular description of preferred embodiments of the system and method as illustrated in the accompanying drawings in which like reference characters refer to the same parts throughout the different views. The drawings are not necessarily to scale, emphasis instead being placed upon illustrating the principles of the invention.

### BRIEF DESCRIPTION OF THE DRAWINGS

FIG. 1 illustrates an exemplary management system that includes a client and template validation tool in accordance with the present invention;

FIGS. 2A and 2B illustrate a general-purpose computer hardware and software architecture, respectively, that may be adapted for practicing embodiments of the invention;

FIG. 3 illustrates an exemplary method for using the validation tool in conjunction with an application under test in accordance with a preferred embodiment of the present invention;

FIGS. 4A-4C illustrate an exemplary method for using the validation tool to monitor the operation of a calendar application under test in accordance with a preferred embodiment of the present invention; and

FIGS. 5A-5P illustrate exemplary user interfaces and display information associated with exemplary embodiments of the present invention.

### DETAILED DESCRIPTION OF THE INVENTION

The embodiments of the invention allow a user such as a quality engineer, to validate the in process memory utilized by client centric applications. In addition, the embodiments of the present invention facilitate testing of the possible states associated with documents in a system, and further make it possible to test memory in an ad hoc fashion. Furthermore, outputs generated by the preferred embodiments can be input to automated test solutions such as, for example, SILK.

SILK is a general-purpose simulation and testing language based on the Java™ programming language, and it lets a user create reusable object-oriented simulation/test components and models. SILK is comprised of modeling components based on the Java Beans™ component architecture. SILK has several key strengths that make it desirable for simulation activities. First, SILK provides a rich set of Java class libraries which can be assembled into a plurality of modeling constructs. Second, SILK is a process-oriented simulation language that makes it possible to program within a standard programming language using industry standard development environments. Third, SILK provides a visual modeling and test environment where components can be graphically assembled for quickly creating simulation applications. Since SILK is Java based, it supports multi-threaded execution making it useful for simulating large scale multi-user applications such as enterprise management systems.

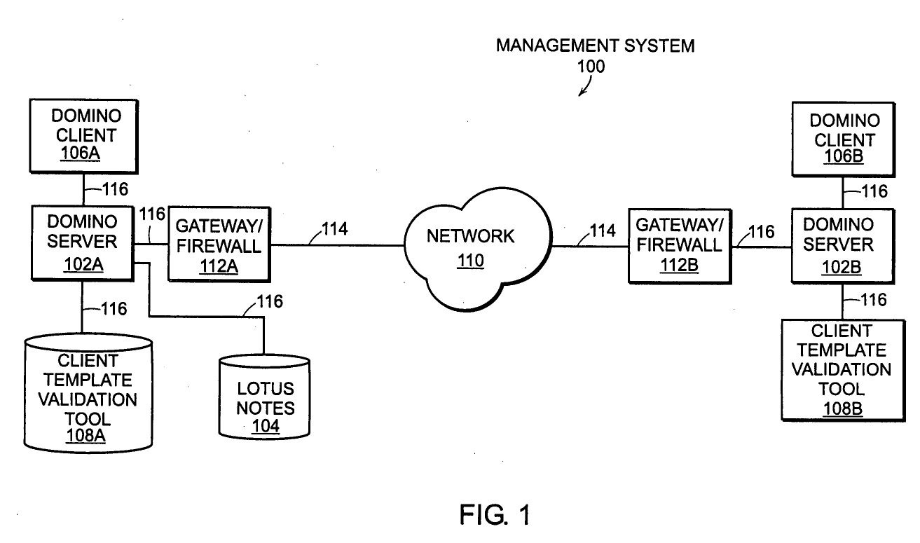

FIG. 1 illustrates an exemplary configuration for a management system 100 in accordance with an aspect of the invention. Management system 100 may include of one or more servers, here Domino™ servers 102A, 102B running at least one version of a workforce collaboration application such Lotus Notes™, hereinafter Notes, 104. In the embodiment illustrated in FIG. 1, one version of a workforce collaboration software application, here Notes is running in connection with server 102A; however, in other implementations, server 102B may also have a local version of Notes instead of operating off the version associated with server 102A by way of network 110. Lotus Notes™ is made by International Business Machines Corp. (IBM) and it includes software and/or hardware for implementing a workforce collaboration and communications environment.

The servers 102A, 102B are coupled to clients 106A, 106B, respectively, which may be Domino clients and are hereinafter generally referred to as Clients. The Clients 106A, 106B may also interact with client and template validation tool (CTVT) 108A, 108B which is used to monitor the operation of user-developed applications and documents. In addition, CTVT 108A, 108B also provide users with the ability to monitor applications in real-time without adversely impairing the operation of the application under test.

Network 110 may be used for communicatively coupling other elements of management system 100. Network 110 may be any type of communications network running any networking protocol. For example, network 110 may be an intranet such as a local area network (LAN) operating within a corporate location or university campus, a metropolitan area network (MAN) operating within a geographic region such as a city and its surrounding suburbs, or a wide area network (WAN) such as the world wide web. In addition, network 110 may run any type of networking protocol such as, for example, transmission control protocol and Internet protocol (TCP/IP), asynchronous transfer mode (ATM), synchronous optical network (Sonet), frame relay, integrated services digital network (ISDN), and open shortest path first (OSPF). Network 110 may employ a plurality of links 114 for coupling network elements and locations. Links 114 may include hardwired links and/or wireless links. Examples of hardwired links include, but are not limited to, coaxial cable, twisted pair cable, and optical fibers; and examples of wireless links include, but are not limited to, radio frequency (RF) such as IEEE 802.11 based links, or free space optical links.

Management system 100 may also have gateways and/or firewalls 112A, 112B for providing access to network 110 and for providing protection against undesirable network traffic such as denial-of-service attacks as well as network traffic containing malicious code such as computer worms and viruses. Links 116 are used to connect elements on the protected side of gateway/firewall 112A and 112B. The implementation of management system 100 shown in FIG. 1 is illustrative; therefore, other implementations of system 100 can be employed without departing from the spirit of the invention.

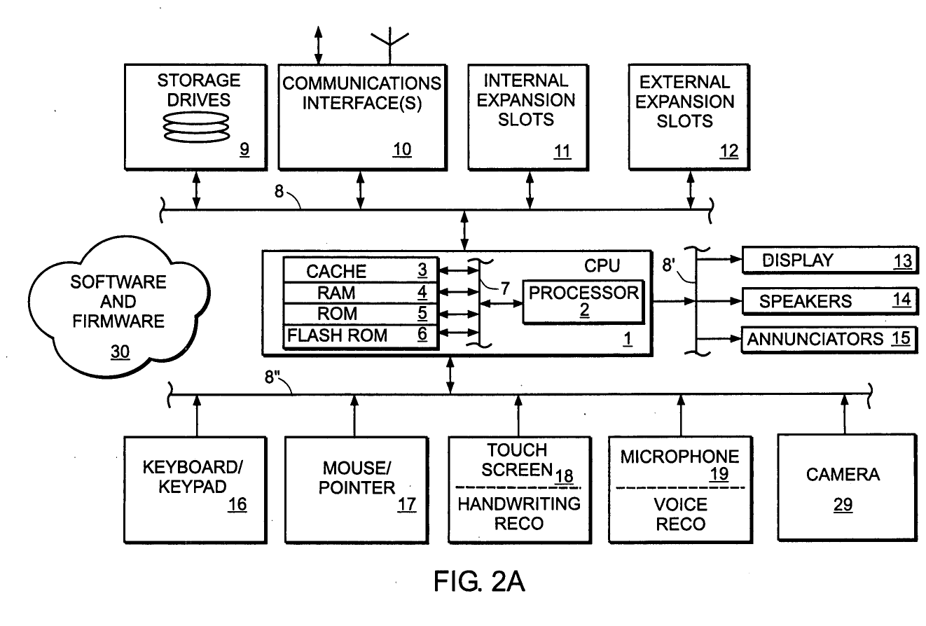

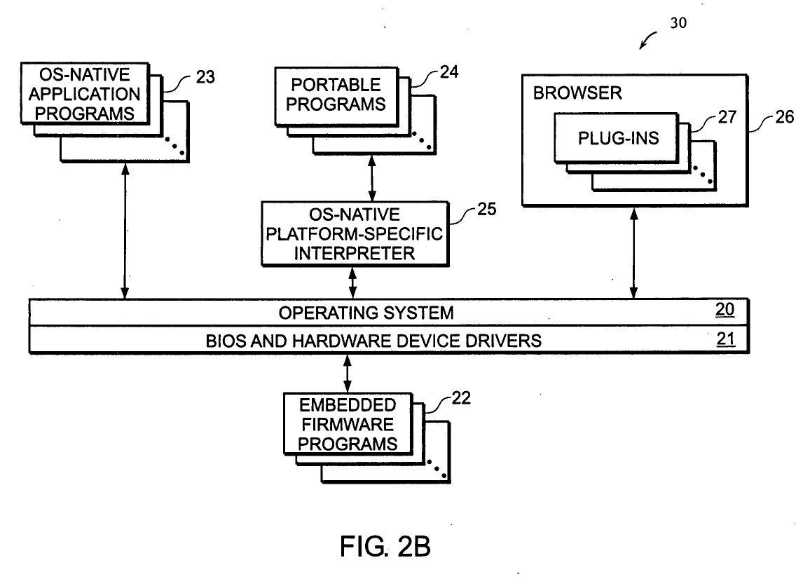

FIGS. 2A and 2B illustrate an exemplary computer hardware architecture and software implementation for various aspects of the invention such as server 102A, 102B and Client 106A, 106B, respectively.

FIG. 2A illustrates a generalized architecture including a central processing unit 1 (CPU), which is typically comprised of a microprocessor 2 associated with random access memory (RAM) 4 and read-only memory (ROM) 5. Often, the CPU 1 is also provided with cache memory 3 and programmable FlashROM 6. The interface 7 between the microprocessor 2 and the various types of CPU memory is often referred to as a local bus, but also may be a more generic or industry standard bus. CPU 1 processes and interprets machine-readable, or function-executable, instructions associated with an operating system, user-developed applications, validation tools, Notes Clients, Notes servers, and test automation tools.

Many computing platforms are also provided with one or more storage drives 9, such as a hard-disk drives (HDD), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network. The RAM is capable of storing machine-readable instructions and information necessary to operate software applications under test as well as validation and test automation tools.

Many computing platforms are provided with one or more communication interfaces 10, according to the function intended of the computing platform. For example, a personal computer is often provided with a high speed serial port (RS-232, RS-422, etc.), an enhanced parallel port (EPP), and one or more universal serial bus (USB) ports. The computing platform may also be provided with a local area network (LAN) interface, such as an Ethernet card, and other high-speed interfaces such as the High Performance Serial Bus IEEE-1394. The computing platform may also be provided with a radio frequency (RF) interface with antenna, as well. And in some cases, the computing platform may be provided with an infrared data arrangement (IRDA) interface, too.

Computing platforms are often equipped with one or more internal expansion slots 11, such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots 12 allowing the user the ability to easily install and remove hardware expansion devices, such as PCMCIA cards, SmartMedia cards, and various proprietary modules such as removable hard drives, CD drives, and floppy drives.

Often, the storage drives 9, communication interfaces 10, internal expansion slots 11 and external expansion slots 12 are interconnected with the CPU 1 via a standard or industry open bus architecture 8, such as ISA, EISA, or PCI. In many cases, the bus 8 may be of a proprietary design.

A computing platform is usually provided with one or more user input devices, such as a keyboard or a keypad 16, and mouse or pointer device 17, and/or a touch-screen display 18. In the case of a personal computer, a full size keyboard is often provided along with a mouse or pointer device, such as a track ball or TrackPoint™. In the case of a portable device such as a PDA, a simple keypad may be provided with one or more function-specific keys as well as a touch-screen 18.

Additionally, a microphone 19, such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device 29, such as a still digital camera or full motion video digital camera which can be used for employee collaboration such as web conferencing.

One or more user output devices, such as a display 13, are also provided with most computing platforms. The display 13 may take many forms, including a Cathode Ray Tube (CRT), a Thin Flat Transistor (TFT) array, or a simple set of light emitting diodes (LED) or liquid crystal display (LCD) indicators.

One or more speakers 14 and/or annunciators 15 are often associated with computing platforms, too. The speakers 14 may be used to reproduce audio and music, such as the speaker of a wireless telephone or the speakers of a personal computer. Annuciators 15 may take the form of simple beep emitters or buzzers, commonly found on certain devices such as PDAs and PIMs.

These user input and output devices may be directly interconnected (8′, 8″) to the CPU 1 via a proprietary bus structure and/or interfaces, or they may be interconnected through one or more industry open buses such as, for example, ISA, EISA, and PCI.

The computing platform is also provided with one or more software and firmware 30 programs to implement the desired functionality of the computing platforms.

FIG. 2B illustrates further detail of a generalized organization of software and firmware 30 on this range of computing platforms. One or more operating system (OS) native application programs 23 may be provided on the computing platform, such as word processors, spreadsheets, contact management utilities, address book, calendar, email client, presentation, financial and bookkeeping programs.

Additionally, one or more portable or device-independent programs 24 may be provided, which must be interpreted by an OS-native platform-specific interpreter 25, such as Java™ scripts and programs.

Often, computing platforms are also provided with a form of web browser or micro-browser 26, which may also include one or more extensions to the browser such as browser plug-ins 27.

The computing device is often provided with an operating system 20, such as, for example, Microsoft Windows™, UNIX®, IBM OS/2™, or AIX®, LINUX, MAC OS™, Sun Solaris™, or other platform specific operating systems. Smaller devices such as PDA's and wireless telephones may be equipped with other forms of operating systems such as real-time operating systems (RTOS) or Palm Computing's PalmOS™.

A set of basic input and output functions (BIOS) and hardware device drivers 21 are often provided to allow the operating system 20 and programs to interface to and control the specific hardware functions provided with the computing platform.

Additionally, one or more embedded firmware programs 22 are commonly provided with many computing platforms, which are executed by onboard or “embedded” microprocessors as part of the peripheral device, such as a microcontroller or a hard drive, a communication processor, network interface card, or sound or graphics card.

As such, FIGS. 1 and 2A and 2B describe in a general sense the various hardware components, software and firmware programs of a wide variety of computing platforms, including but not limited to personal computers, workstations, servers, Notes Clients, Notes servers, web-enabled telephones, and other like appliances. The preferred embodiments of the present invention include the processes and methods preferably implemented as software and firmware on such a computing platform for validating software applications under test. It will be readily recognized by those skilled in the art that the following methods and processes may be alternatively realized as hardware functions, in part or in whole, without departing from the spirit and scope of the invention.

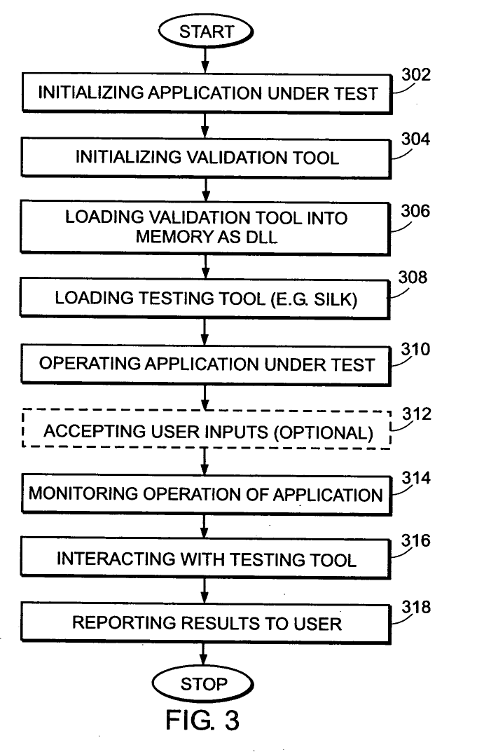

FIG. 3. illustrates an exemplary method for implementing the invention for validating user developed documents, templates and applications. A user initializes an application under test such as a Notes application employing templates (per step 302). Next, the CTVT is initialized (per step 304) and loaded into memory on client 106A as a dynamic link library (DLL).

A DLL is a binary file containing functions which can be called by one or more processes operating on a computer. A DLL is loaded into system memory at system startup, or at the startup of a particular software application. Once a DLL is loaded, multiple applications can access it simultaneously. For example, if a database application has three modules input, output and processing, respectively, that need to access a database, a programmer can write a DLL for handling communication to the database. The three modules can then call the DLL to communicate with the database.

A testing tool known in the art may be loaded and initialized (per step 308). By way of example, SILK may be loaded in step 308 to facilitate automation of testing and diagnostics of an application under test. The particular application under test is then executed (per step 310). If the application under test requires user inputs, they may be entered (per step 312). The application under test is monitored (per step 314). The application under test then interacts with the CTVT during operation (per step 316). The CTVT captures information about the application under test, such as, for example, memory usage, sequence of operational steps, input/output operations and data and formulates them into results which are reported to a user such as a quality control engineer (per step 318).

The CTVT provides a nonprogrammer the ability to create and deploy test logic for monitoring the in memory Notes of a Client. This allows the user to validate fields, hide-when formula validations, databases, directories and documents, as well as many other in memory or back end processing not otherwise available to a user of the application under test.

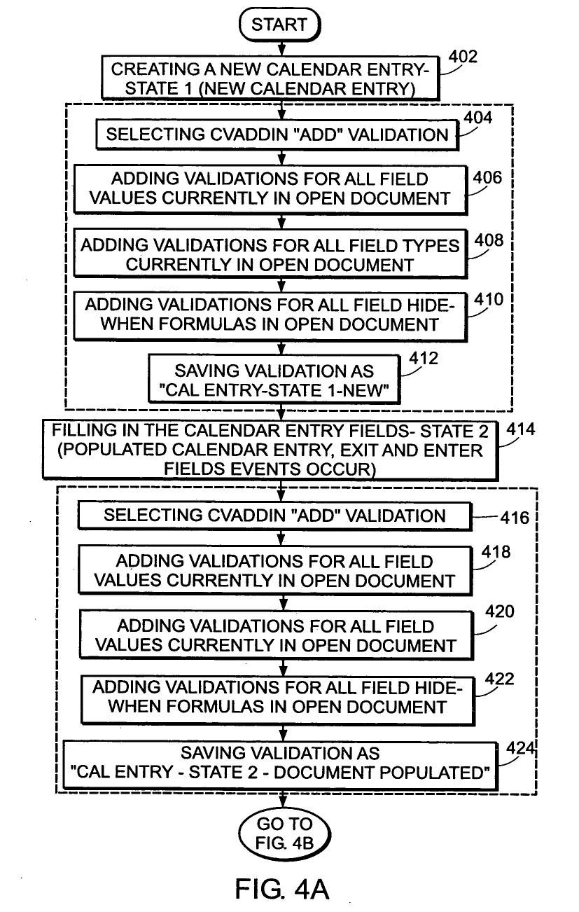

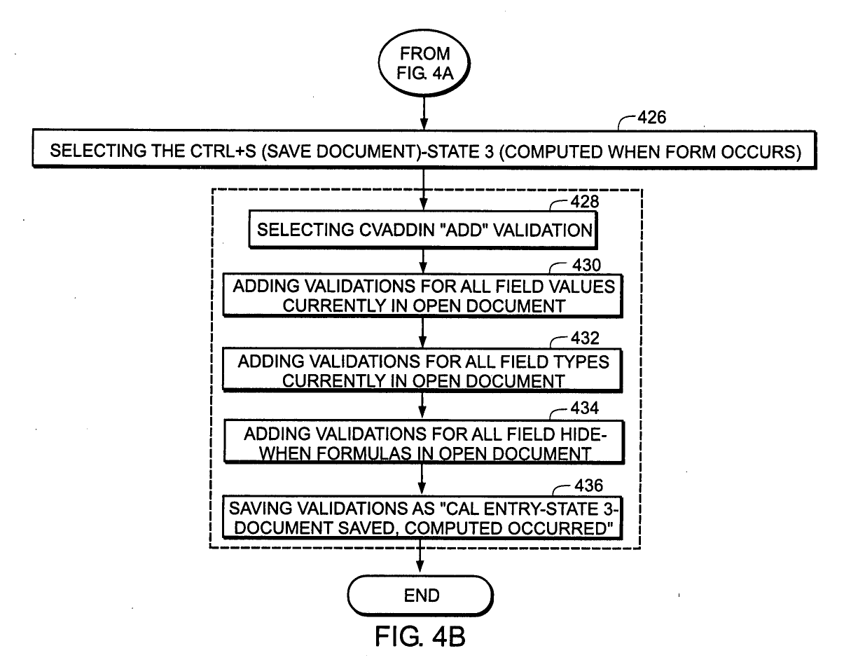

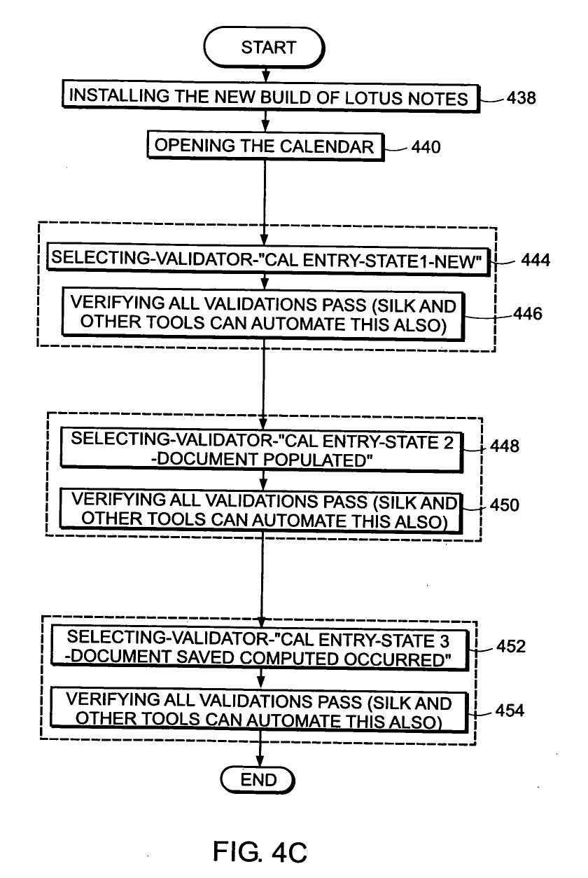

FIGS. 4A-4C illustrate an exemplary method for validating an exemplary application, here a calendaring application, using an embodiment of the invention. The user creates a new calendar entry as a first state (per step 402). In an embodiment of the invention, the CTVT may be loaded into the Client as a menu addin and used to validate states of the calendaring application. In Notes, this may be accomplished, for example, using the Notes.invariable AddinMenus=cvAddin.DLL. A CVAddin “Add” validation button displayed to the user may then be selected using a mouse 17 (per step 404). Validations for all field values currently in the open document may be added (per step 406), as well as validations for all field types currently in the open document (per step 408).

Validations for all field hide-when formulas are added (per step 410), and then the validation may be saved as, for example, “Cal Entry—State 1—New” (per step 412). Calendar entry fields may then be populated in a second state (per step 414).

A CVAddin add validation may be selected using the mouse 17 (per step 416). Then, validations for all field values, field types and field hide-when formulas currently in the open document may be added (per steps 418, 420 and 422, respectively). The validation may then be saved as, for example, “Cal Entry—State 2—Document populated” (per step 424).

A third state may commence when a keystroke combination such as CTRL+S is entered to save a document (per step 426). A CVAddin “ADD” validation is selected (per step 428). Validations for all field values, all field types and all field hide-when formulas may be added in the open document (per steps 430, 432 and 434, respectively). Then the validation may be saved as, for example, “Cal Entry—State 3—Document saved, Computed Occurred” (Per step 436).

The method illustrated with respect to FIGS. 4A and 4B produce “Gold” log validations which may be saved in a file format such as extensible markup language (XML) for use in an automated test suite such as SILK.

FIG. 4C illustrates an exemplary method showing how menu options discussed hereinabove may be used in SILK or with a manual test and validation tool. A new build of the application containing the calendaring tool may be installed (per step 438), and then the calendar is opened (per step 440). A new calendar entry may be created by clicking “validator” and “Cal Entry—State 1—new” using a computer mouse 17 or other pointing device (per step 444).

A user, such as a quality engineer, verifies that all validations pass either manually or using an automated tool such as SILK for accomplishing the verification (per step 446). Calendar entry fields are populated (per step 448). For example, a user may click validator “Cal Entry—State 2—Document populated” using a mouse 17. Then a verification is made that all validations pass (per step 450). The calendar entry is then saved (per step 452). By way of example, the calendar entry may be saved by clicking validator “Cal Entry—State 3—Document saved Computed Occurred” using a computer mouse. Then a verification is made that all validations pass the testing criteria (per step 454).

For the exemplary method of FIGS. 4A-4C, the CV Addin tool may have performed numerous validations as the method steps are accomplished. By way of example, for state 1 “Cal Entry—State 1—New” a time of 4 seconds may have been used with 317 tests validated. Examples of tests validated may be fields, value, type and hide-whens. For State 2 “Cal Entry—State 2—Document populated” a time of 5 seconds may have been used, while 337 tests were validated. And, for State 3 “Cal Entry—State 3—Document saved, computed occurred” may have taken 5 seconds and performed 353 tests. The testing above would have taken approximately 14 seconds and performed 1,007 tests. As seen from this example, the validator provides a robust evaluation ability without adversely impacting the normal operation of the calendaring software application under test.

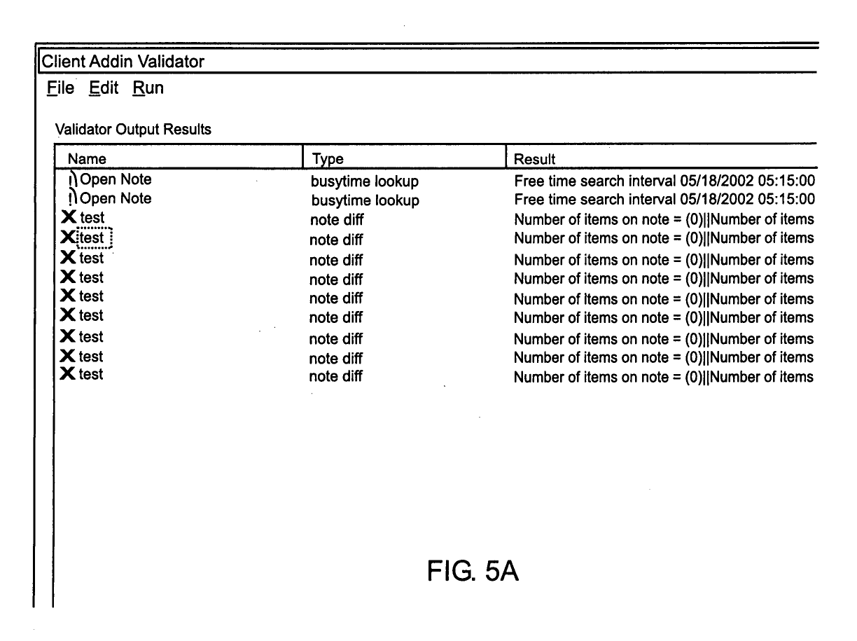

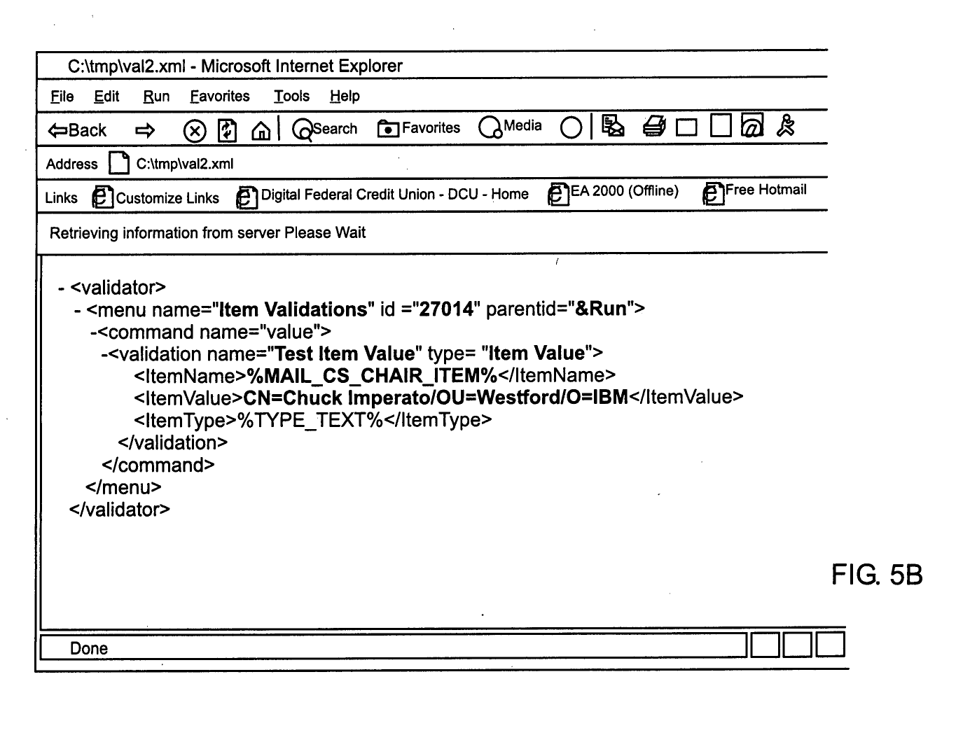

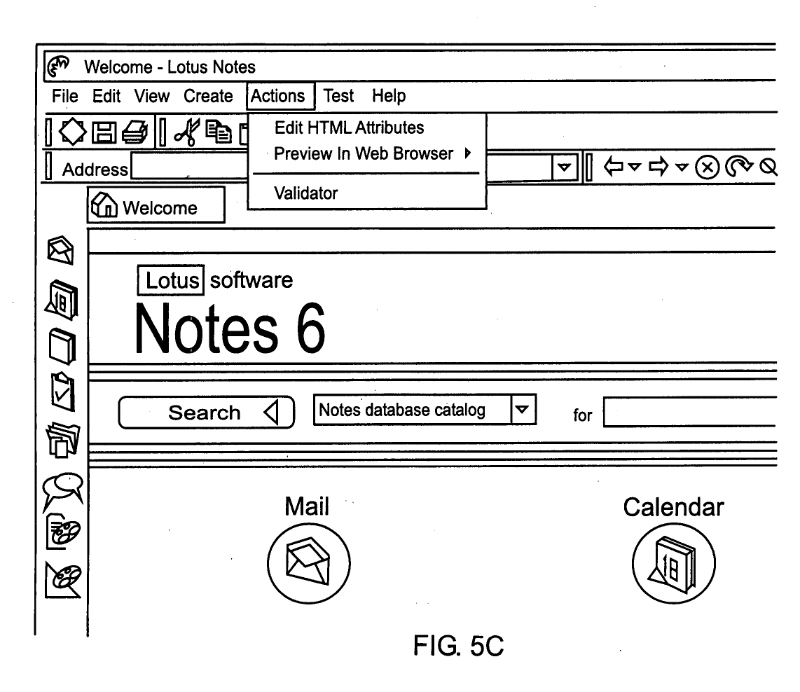

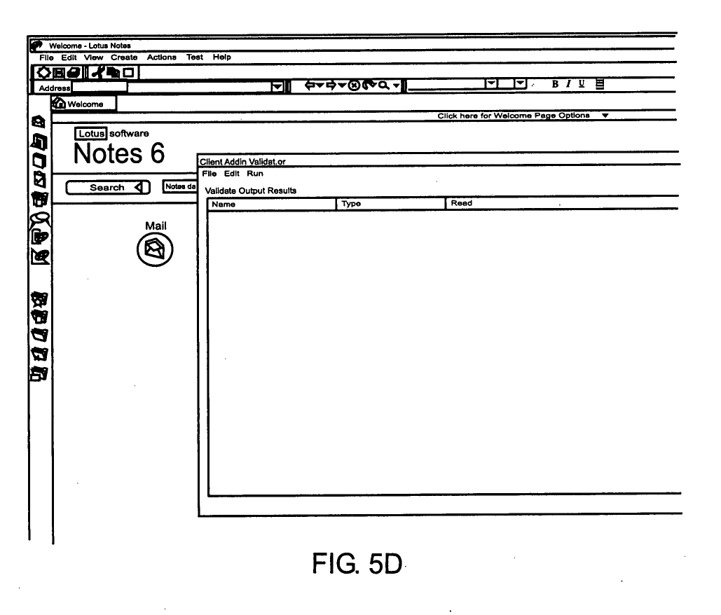

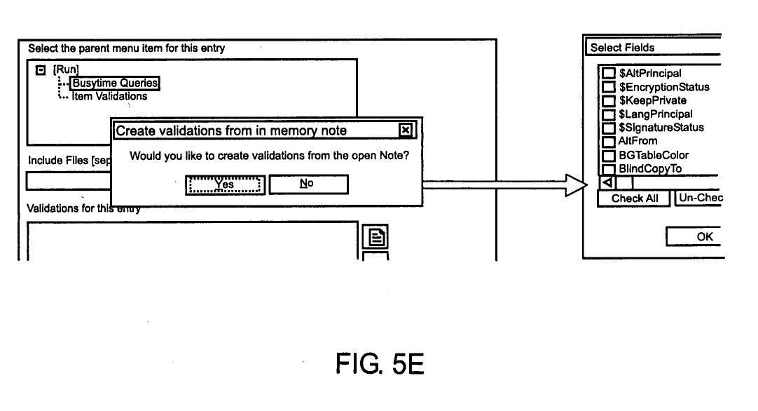

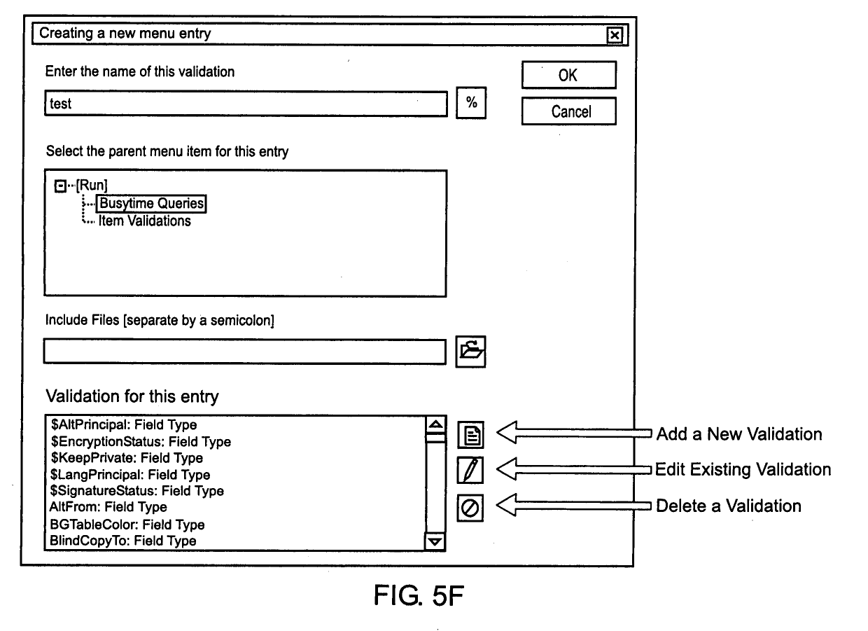

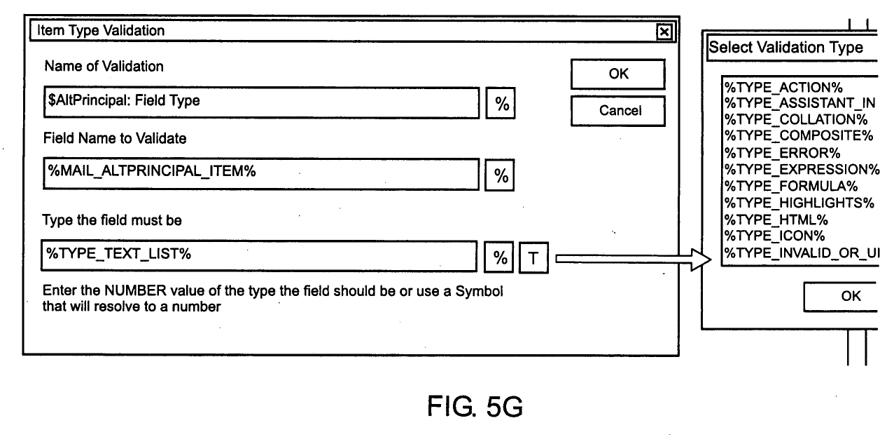

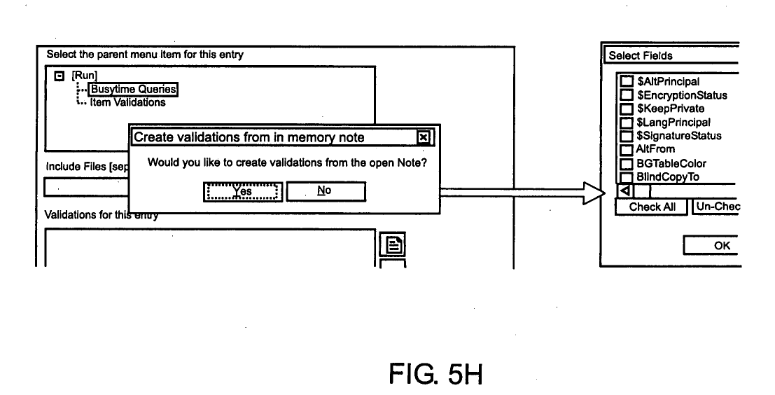

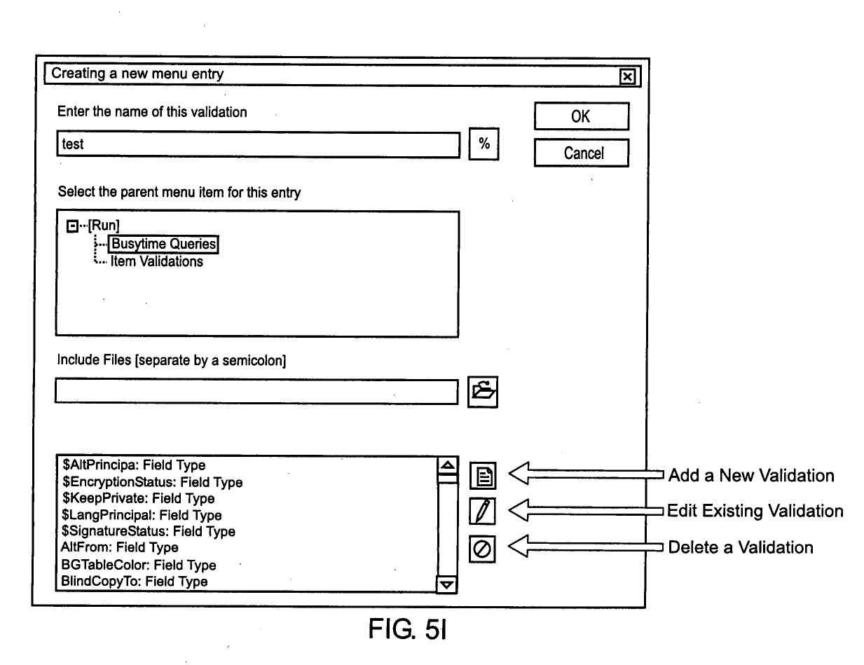

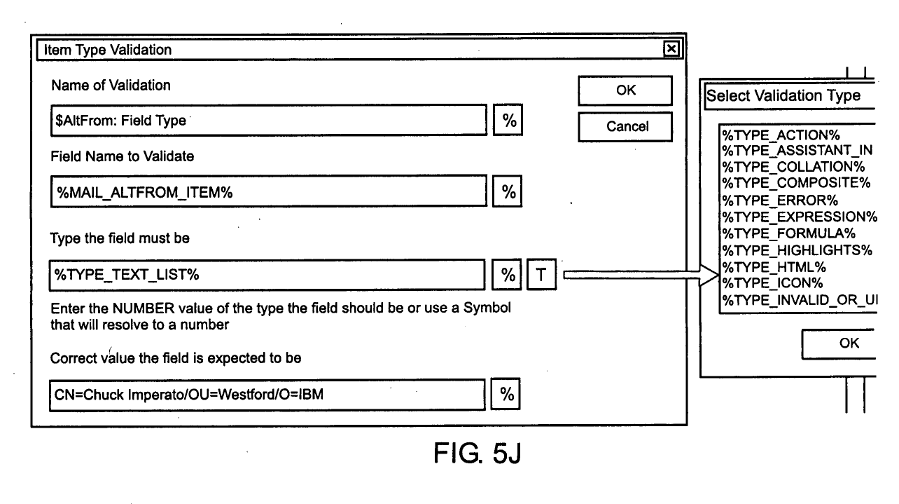

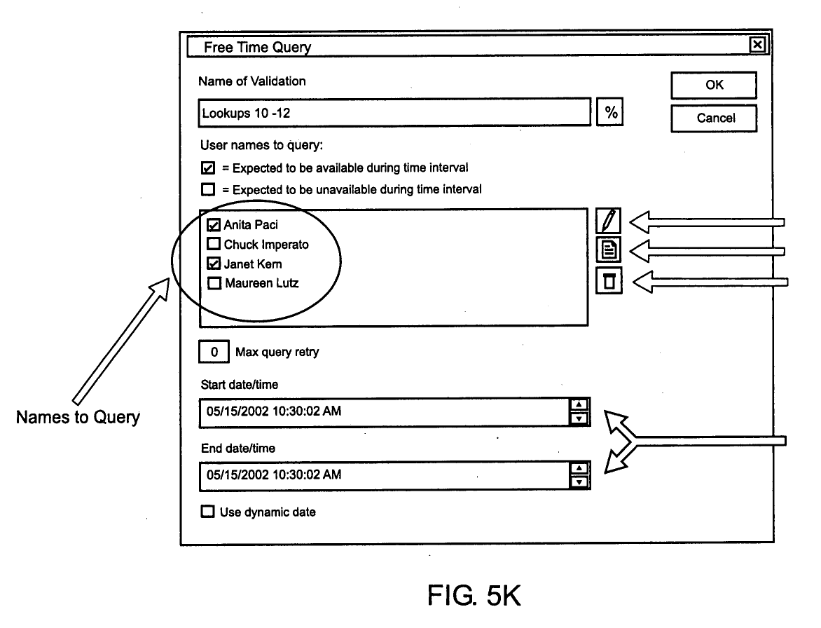

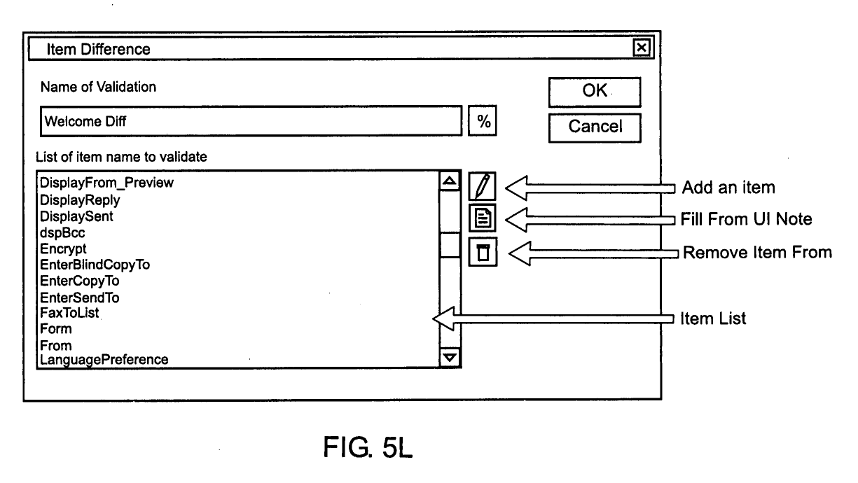

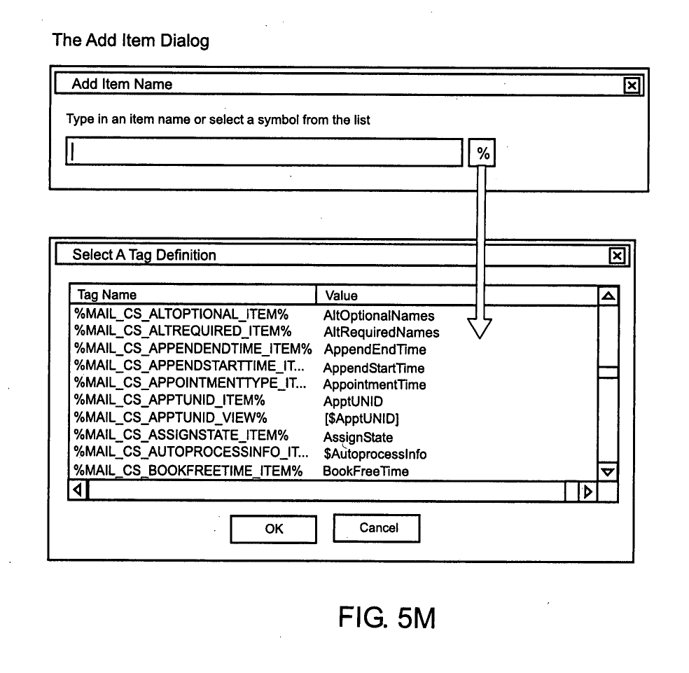

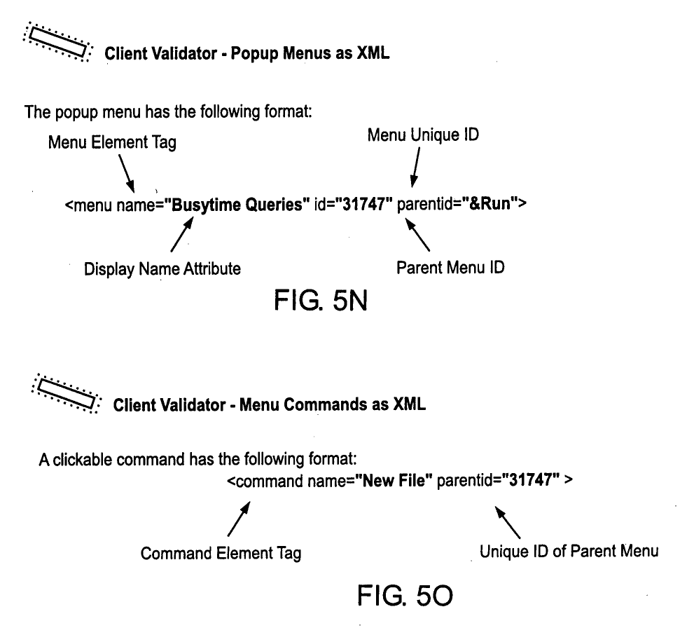

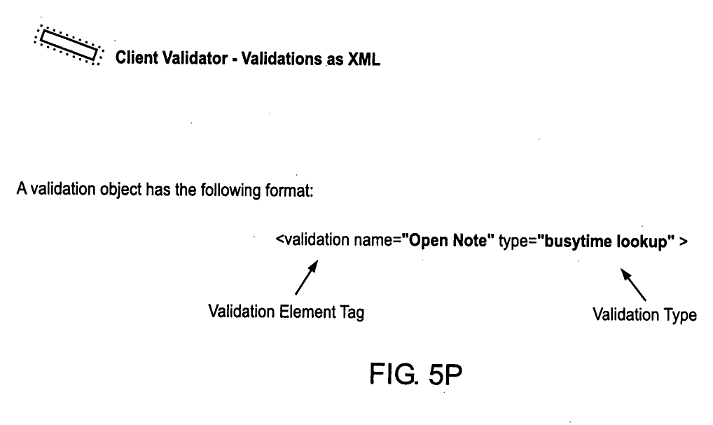

FIGS. 5A-P illustrate exemplary user displays and graphical user interfaces that are useful when practicing a preferred embodiment of the invention. Embodiments of the invention may be used to evaluate both front end data and back end data created through the use of a client application such as a Notes client. Since the invention operates as a DLL, it runs within the memory space of the application under test. As a result, the invention may utilize data from a document currently open in a user interface (GUI) editor, thus giving the invention access to all items associated with the document under test.

Aspects of the embodiment discussed in conjunction with FIGS. 5A-P were implemented as a Notes client add-in using core Notes application program interfaces (APIs) and the Microsoft® Windows SDK. Controls utilized were standard Windows® controls and were implemented in an object oriented fashion using C++. The validation tool code was built into a DLL located in the notes binary directory. The illustrated embodiment executes tests from the run menu and displays results in the list view of a main screen. The embodiment of the validator illustrated in FIGS. 5A-P produces three types of results which are denoted as follows:

PASS: The result is displayed with a green check mark signaling that the test executed and that the validation was successful.

FAIL: The result is displayed with a red X signaling that the test executed and the validation was unsuccessful.

WARNING: The result is displayed with a yellow exclamation icon signaling the test executed and the validation was undetermined.

FIG. 5A illustrates an exemplary display showing test validation output results produced using the invention. FIG. 5B illustrates an exemplary display containing an XML file for an Item Value validation as seen by a user using a web browser.

To run the validator, all Notes processes running on the client device may be closed down. Next, a file associated with the DLL is copied into the Notes client binary directory. For example, a file NCVAddin.DLL may be copied. The notes.ini file on the client is modified to include an entry for the validator such as, for example, “Addin Menus—NCVAddin.DLL”. To begin using the validator tool, a user may click on the Actions menu entry and select the validator as shown in FIG. 5C. Any XML files included in a user's preference settings may be loaded before displaying a main screen. Selecting validator will produce the display of FIG. 5D, and clicking on Run in FIG. 5D launches the validator.

Validation of Item Type may occur by having a user select it from the validation type selection dialog. A user may then be asked if they want to create the command off of a user interface note, which may be a note not yet saved to disk. If the user selects yes, another dialog box may appear containing all of the item names in the document and further containing a check box next to each item as shown in FIG. 5E. A user may then check the desired items using mouse 17.

FIG. 5F shows a user interface containing a display produced when a user chooses to create the command from the open note. The display includes all items listed in the validation list window. Each of the listed validations may be executed when the command is clicked in the menu. This feature may be useful when a user has a note containing valid data that the user wishes to use as a validation means for a different note.

In contrast to FIG. 5F, if a user chooses not to create the command from the open note, the user may be prompted with an Item Type validation dialog window as illustrated in FIG. 5G. The user may enter a name for the validation, the name of the item whose type is being checked, and the expected or correct type of the item. The user may then enter a type or click on the button labeled “T” to select a predefined type in Notes. Upon execution, the item type validation checks the data type of the item on the current in-memory note and reports a PASS of the actual type for the items matching the expected type that the user specified in the item type dialog window.

An item value may be validated by creating an Item Value validation command. A user may be asked if they would like to create the command off of the user interface note if there is an open note in the user interface workspace. If “Yes” is selected, another dialog box may appear containing all of the item names in the document along with a check box next to each one as shown in FIG. 5H. The user may then select desired items. If the user chooses to create the command from the open note, they may be returned to the command dialog where the item names are listed as shown in FIG. 51. When the user clicks the command, the identified validations are executed.

The display of FIG. 5I is useful when a user has a note containing validated data and it is desired to use that data as a validation mechanism for another note.

FIG. 5J illustrates a user display that may be used when a user chooses not to create the command from the open note. The user is prompted with the Item Value validation dialog. The user enters a name for the validation, the name of the item whose value is being checked, the type of the item and an expected or correct value of the item. Predefined types may be selected when the user clicks on the “T” button. Upon execution, the Item Value validation checks the value of the item on the current in-memory note and reports a PASS if the actual value of the item matches the expected value the user has specified in the Item Value dialog box.

If a user wants to create a Busytime Lookup validation command, Busytime Lookup may be selected from the validation type selection dialog as shown in FIG. 5K. The Busytime Lookup window allows the user to enter custom validation parameters. For example, a Busytime Lookup validation may be created by entering a name for the validation or selecting a symbol name from the list, clicking on the button marked with a pencil to add a new user name to the list of queried names, and specifying the number of times the validation should retry the busytime query if it cannot obtain schedule information for a particular name on the first attempt. The check boxes next to the names of FIG. 5K identify that the particular person is expected to be available during the indicated time interval. When the test is run, if a person is expected to be available and the data retrieved from the Domino server comes back as available, then the test will report a PASS. If a person is expected to be unavailable, then the test will report a FAIL. If no schedule information could be retrieved for the user, then a WARNING is issued with a description of the returned STATUS code. A “use dynamic date” box may be included to allow a user to specify a time interval. For example, checking the use dynamic date box may remove the date portion of the time entry such that the validation uses the current date (i.e. date that test is run) and the user specified time interval. The use of a dynamic date lets a user create numerous validations that can run via SILK automation without requiring that dates be modified to use the current date.

FIG. 5L illustrates a display produced when a user selects Note Diff from the validation type selection dialog. The Note Diff validation may be created by entry of a name for the validation or selection of a symbol from the list and clicking on the button marked with a pencil to add the new item to the list. The add item dialog allows the user to use symbols by clicking on the button marked with a “%” sign as shown in FIG. 5M. When the Note Diff validation is executed, it checks the current user interface note for all of the items in the specified item list. If the item exists on the note being evaluated, a PASS will be reported. In contrast, if the item is not found on the note, a FAIL will re reported. If a note item is found that is not present in the specified list, a WARNING is reported. Also, the number of items found on the note is reported and compared to the number of items in the list.

The popup windows utilized with embodiments of the invention disclosed herein may be XML driven. FIG. 5N illustrates an exemplary XML syntax useful for implementing display windows of the invention. A menu ID uniquely identifies the menu element. The parent ID attribute specifies the popup menu of which this element is a child. Menu definitions may be nested within each other in the same document, or menus can have parents which are defined in separate XML documents. If a menu element is nested within another menu element, it is not necessary to include a parent ID attribute.

FIG. 5O illustrates an exemplary XML syntax that is useful when implementing menu commands in a client validation process. The XML commands may be clickable in that the particular command is implemented when a user places a mouse cursor over the icon associated with the command and depresses one of the mouse buttons. A menu command may be comprised of a command element tag and a unique ID associated with a parent menu.

FIG. 5P illustrates an XML syntax that may be used for representing a validation object. The validation object of FIG. 5P contains a validation element tag and a validation type. The validation type attribute identifies validation types that are supported by the validation tool. Examples of validation types that can be supported are, but are not limited to, Item Type, Item Value, Note Diff, Busytime Lookup, Effective Policy, Remote Console, and the like.

While exemplary embodiments of the invention have been described and illustrated hereinabove, the invention is not limited thereto. Many alternative embodiments and implementations are possible in light of the disclosure without departing from the spirit of the invention. For example, the validation tool may be deployed in a distributed architecture where the user is located at a first geographic location, the application under test is located at a second geographic location and the validation tool components are located at a third geographic location. The three locations may be connected by way of a high speed data network such as the world wide web. When the user launches the validation tool, the necessary functional code may be sent to the hardware running the application at the second location by way of the network. The functional code may then be placed in system memory as a DLL where the application resides. Then the user may run the application and view validation results on a display device at the first location.

Many changes in the details, materials and arrangements of parts, herein described and illustrated, can be made by those skilled in the art in light of teachings contained hereinabove. Accordingly, it will be understood that the following claims are not to be limited to the embodiments disclosed herein and can include practices other than those specifically described, and are to be interpreted as broadly as allowed under the law.

1. A method for validating a software application comprised of machine-readable instructions operating on a computer, said method comprising the steps of:
making an in process memory available, said memory having at least a first portion and a second portion;
making a processor available for executing said machine-readable instructions;
loading said machine-readable instructions into said memory in a manner causing said instructions to occupy said first portion;
receiving a validator comprised of function-executable instructions, said validator for use in verifying the operation of said software application;
loading said validator into said second portion of said memory; and
making said second portion of said memory available to said first portion thereby allowing said validator to validate said software application by way of said in process memory.

2. The method of claim 1 wherein said validator is in the form of a dynamic link library.

3. The method of claim 1 wherein said computer is a client.

4. The method of claim 3 wherein said software application includes a state when operating on said client.

5. The method of claim 4 wherein said validator is capable of monitoring and validating said state.

6. The method of claim 1 wherein said software application further comprises members selected from the group including fields, hide-when formulas, databases, directories, documents and templates.

7. The method of claim 6 wherein said validator is further capable of validating said members to produce validated members and a validated state, said validator further making said validated members and said validated state available to an interface.

8. The method of claim 7 wherein said interface makes said validated members and said validated state available to a user interface.

9. The method of claim 7 wherein said interface makes said validated members and said validated state available to an automated test solution.

10. The method of claim 7 wherein said validated members and said validated state are associated with responses selected from the group including PASS, FAIL, and WARNING.

11. The method of claim 7 wherein said validator includes function-executable instructions which are associated with a programming language selected from the group consisting of C, C⁺⁺, Java, XML, and HTML.

12. The method of claim 7 wherein said software application is a Notes client.

13. An apparatus for validating the operation of a software application comprised of first machine-readable instructions, said apparatus comprising:
a memory having a first portion and a second portion, said first portion storing said first instructions associated with said software application and said second portion storing second instructions associated with a validator that validates said software while operating, said memory further capable of allowing said validator to monitor said first portion while said software application is operating;
a processor communicatively associated with said memory, said processor further executing said first and second instructions thereby facilitating validation of said software application by said validator;
a user interface communicatively associated with said processor displaying a validation result to a user; and
an output interface communicatively associated with said processor providing a validation result to an external application.

14. The apparatus of claim 13 wherein said validator operates as an in memory dynamic link library while validating said software.

15. The apparatus of claim 14 wherein said external application is SILK.

16. The apparatus of claim 15 wherein said apparatus is a Notes client.

17. The apparatus of claim 16 wherein said Notes client communicates with a Notes server over a network.

18. The apparatus of claim 16 wherein said software and said validator are comprised of executable instructions associated with a C⁺⁺ programming language.

19. A method operating on a Notes client for validating the operation of a software application communicatively associated with a server coupled to a network, said method comprising the steps of:
making an in process memory available, said memory capable of holding a first set of machine-readable instructions in a first portion of said memory and a second set of machine-readable instructions in a second portion of said memory;
making a processor available, said processor communicatively associated with said memory;
loading said first set of instructions into said first portion, said first set of instructions further associated with said software application;
loading said second set of instructions into said second portion, said second instructions further associated with a validator capable of monitoring said first set of instructions in said memory;
producing a validation result, said result associated with operation of said software while said validator is monitoring; and
making said validation result available to a user interface.

20. A computer program product comprising machine-readable instructions for causing a processor to perform a method for validating the operation of a software application operating on a computer, said method comprising the steps of:
making a memory available, said memory having at least a first portion and a second portion;
loading a validator for use in validating operation of said software application;
making said processor available for executing said machine-readable instructions, said machine-readable instructions comprised of a first set associated with said software application and a second set associated with said validator;
loading said first set of instructions into said first portion of memory;
loading said second set of instructions into said second portion of memory;
making said second portion available to said first portion;
determining a validation result using said first set and said second set of instructions; and
making said validation result available to a user interface.
